(19) United States
(12) Patent Application Publication
(10) Pub. No.: US 2016/0026288 A1
(43) Pub. Date: Jan. 28, 2016

(54) TOUCH DISPLAY PANEL, DISPLAY DEVICE AND METHOD FOR MANUFACTURING COLOR FILTER SUBSTRATE

(71) Applicants: BOE TECHNOLOGY GROUP CO., LTD., Beijing (CN); BEIJING BOE DISPLAY TECHNOLOGY CO., LTD., Beijing (CN)

(72) Inventors: Hongming ZHAN, Beijing (CN); Ming CHEN, Beijing (CN); Woong KIM, Beijing (CN)

(73) Assignees: BOE TECHNOLOGY GROUP CO., LTD., Beijing (CN); BEIJING BOE DISPLAY TECHNOLOGY CO., LTD., Beijing (CN)

(21) Appl. No.: 14/429,950

(22) PCT Filed: Jun. 12, 2014
(86) PCT No.: PCT/CN2014/079699

§ 371 Date: Mar. 20, 2015

(30) Foreign Application Priority Data
Sep. 24, 2013 (CN) 201310439191.7

(51) Int. Cl. G06F 3/044; G02F 1/1335; G02F 1/1333; G06F 3/041

(52) U.S. Cl. CPC G06F 3/044; G06F 3/0412; G02F 1/133516; G02F 1/133512; G02F 1/13338; G06F 2203/04103

(57) ABSTRACT

The present disclosure provides a touch display panel, a display device and a method for manufacturing a color filter substrate. The touch display panel includes a touch section and a display section. The display section includes an array substrate, a color filter substrate and a liquid crystal layer provided between the array substrate and the color filter substrate. The touch section includes: a touch substrate arranged parallel to the color filter substrate and located at a side of the color filter substrate away from the liquid crystal layer; first electrodes provided on the touch substrate and configured to sense user's touch so as to generate a touch signal; and second electrodes provided on the color filter substrate and configured to output the touch signal.

### CROSS-REFERENCE TO RELATED APPLICATION

This application claims a priority of the Chinese Patent Application No. 201310439191.7 filed on Sep. 24, 2013, which is incorporated herein by reference in its entirety.

### TECHNICAL FIELD

The present disclosure relates to the field of liquid crystal display technology, in particular to a touch display panel, a display device and a method for manufacturing a color filter substrate.

### BACKGROUND

As a convenient inputting display mode, a touch function has been more and more widely applied in various display areas. As shown in FIG. 1, a conventional capacitive touch panel includes an array substrate 1 and a color filter substrate 3. Between the array substrate 1 and the color filter substrate 3, there is filled with a liquid crystal layer 2. The color filter substrate 3 includes a black matrix 31, a pixel unit 32, and a common electrode layer 33 formed on a base substrate. In order to enable a touch function, it is required to specifically produce two glass substrates (cover glass) 4 outside the color filter substrate 3, and the upper and lower glass substrates are formed with ITO (indium tin oxide) sensors 5 with a sensing function, respectively. The touch sensing function is enabled by mounting a driver circuit. Obviously, the production cost thereof is relatively high.

### SUMMARY

An object of the present disclosure is to provide a touch display panel, a display device and a method for manufacturing a color filter substrate, so as to improve the productivity and reduce the production cost.

In one aspect, the present disclosure provides in one embodiment a touch display panel, including a touch section and a display section, wherein the display section includes an array substrate, a color filter substrate and a liquid crystal layer provided between the array substrate and the color filter substrate. The touch section includes a touch substrate arranged parallel to the color filter substrate and located at a side of the color filter substrate away from the liquid crystal layer; first electrodes provided on the touch substrate and configured to sense user's touch so as to generate a touch signal; and second electrodes provided on the color filter substrate and configured to output the touch signal.

Further, the first electrodes and the second electrodes are arranged in a staggered manner to form a matrix structure.

Further, third electrodes for displaying are provided at a display region of the color filter substrate, the second electrodes are provided at a non-display region of the color filter substrate, and the third electrodes and the second electrodes are arranged independently of each other.

Further, the color filter substrate includes: a base substrate; black matrices provided at a non-display region of the base substrate; and pixel units provided at a display region of the base substrate, wherein the second electrodes are provided on the black matrices and the third electrodes are provided on the pixel units.

Further, the first electrode is provided at a surface of the touch substrate close to the color filter substrate.

Further, the touch substrate is a glass substrate.

In another aspect, the present disclosure provides in one embodiment a display device including the above-mentioned touch display panel

In yet another aspect, the present disclosure provides in one embodiment a method for manufacturing a color filter substrate for use in a touch display panel, including steps of:

forming black matrices on a base substrate by a patterning process;

forming pixel units by a patterning process;

forming second electrodes on the black matrices by a patterning process; and

forming third electrodes on the pixel units by a patterning process.

Further, the second electrodes and the third electrodes are formed by a single patterning process.

According to the embodiments of the present disclosure, only one touch substrate is required to achieve the touch function, and as a result, it is able to improve the productivity and reduce the production cost.

### BRIEF DESCRIPTION OF THE DRAWINGS

FIG. 1 is a schematic view showing a touch display panel in the related art; and

FIG. 2 is a schematic view showing a touch display panel according to one embodiment of the present disclosure.

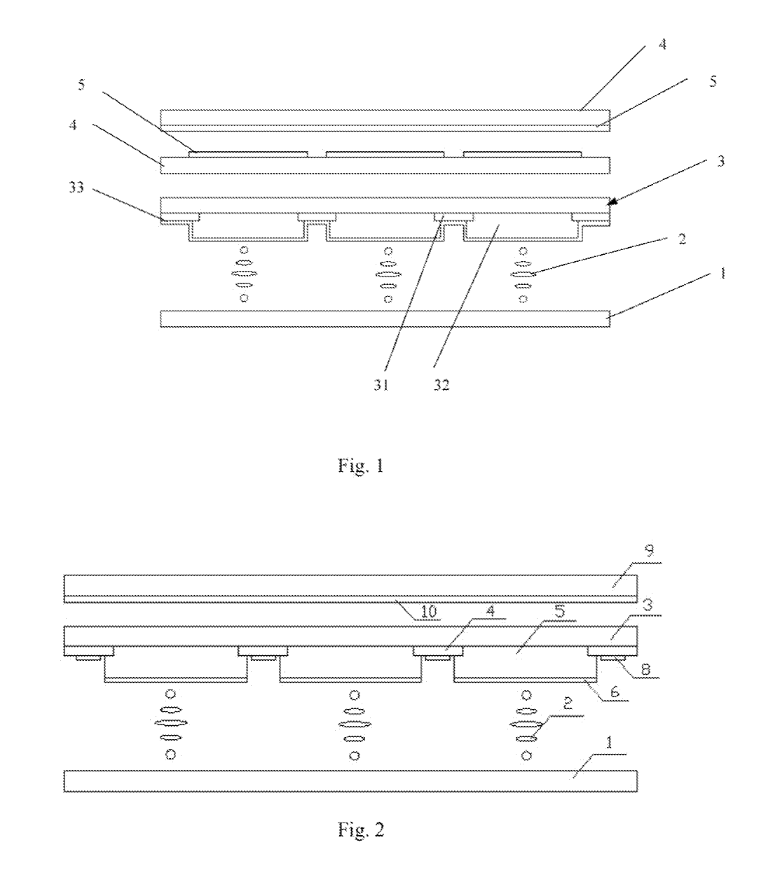

### DETAILED DESCRIPTION

The structures and principles of the present disclosure will be described hereinafter in conjunction with the drawings and embodiments. The following embodiments are for illustrative purposes only, but shall not be used to limit the scope of the present invention.

As shown in FIG. 2, the present disclosure provides in one embodiment a touch display panel, which includes a touch section and a display section. The display section includes an array substrate 1, a color filter substrate 3 and a liquid crystal layer 2 provided between the array substrate 1 and the color filter substrate 3.

The touch section includes:

a touch substrate 9 arranged parallel to the color filter substrate 3 and located at a side of the color filter substrate 3 away from the liquid crystal layer;

first electrodes 10 provided on the touch substrate 9 and configured to sense user's touch so as to generate a touch signal; and

second electrodes 8 provided on the color filter substrate 3 and configured to output the touch signal.

In this embodiment, the second electrodes 8 provided on the color filter substrate 3 are used as electrodes for sensing the touch, and only one touch substrate 9 with the first electrodes 10 is provided so as to achieve the touch function. As a result, it is able to improve the productivity and reduce the production cost.

Specifically, the first electrodes 10 and the second electrodes 8 are arranged in a staggered manner so as to form a matrix structure.

During the operation, when an outer surface of the touch substrate 9 is touched, a capacitance between the first electrode 10 and the second electrode 8 is changed, so as to generate a touch signal. Then, the second electrode 8 outputs the touch signal, so as to determine a touch position.

Third electrodes 6 and the second electrodes 8 are arranged, independently of each other, at a display region and a non-display region of the color filter substrate 3, respectively.

The color filter substrate 3 includes black matrices 4 located at the non-display region and pixel units 5 located at the display region. The second electrodes 8 are provided on the black matrices 4 and the third electrodes 6 are provided on the pixel units 5.

A common electrode layer integrally formed on the black matrices 4 and the pixel units 5 in the related art is divided into the second electrodes 8 as well as the third electrodes 6 having the original function. The second electrodes 8 are extracted through a separate circuit so as to output the touch signal.

The pixel unit 5 is an insulator, and an edge of the second electrode 8 may be in contact with that of the pixel unit 5. In order to separate the second electrode 8 from the third electrode 6 in a better manner, a gap may also be provided between the third electrode 8 and the pixel unit 5, and a size of the gap may be set in accordance with the practical need.

The first electrodes 10 are provided at a surface of the touch substrate 9 close to the color filter substrate 3.

The touch substrate 9 is a glass substrate.

The present disclosure further provides in one embodiment a display device, which includes the above-mentioned touch display panel. The structure and working principle of the touch display panel included in the display device are the same as those mentioned above, and thus will not be repeated herein. Further, structures of the other sections of the display device may refer to the related art, and they will not be particularly defined herein. The display device may be any product or member having a touch display function, such as a household appliance, a communication equipment, an engineering equipment, or an electronic entertainment product.

The touch display panel in this embodiment includes the color filter substrate 3, the array substrate 1, the touch substrate 9, and the liquid crystal 2 provided between the color filter substrate 3 and the array substrate 1. As compared with the related art, the third electrode 6 still maintains the display function but it is separated from the second electrode 8. As a result, the second electrode 8 and the first electrode 10 interact with each other, so as to achieve the touch function.

The present disclosure further provides in one embodiment a method for manufacturing a color filter substrate for use in a touch display panel, including steps of:

forming the black matrices 4 on the base substrate by a patterning process;

forming the pixel units 5 by a patterning process;

forming the second electrodes 8 on the black matrices 4 by a patterning process; and

forming the third electrodes 6 on the pixel units 5 by a patterning process.

In this embodiment, the second electrodes 8 and the third electrodes 6 may be formed simultaneously by a single patterning process, so as to improve the working efficiency.

The above are merely the preferred embodiments of the present disclosure. It should be noted that, a person skilled in the art may make further improvements and modifications without departing from the principle of the present disclosure, and these improvements and modifications shall also fall within the scope of the present disclosure.

What is claimed is:

1. A touch display panel, comprising a touch section and a display section, wherein the display section comprises an array substrate, a color filter substrate and a liquid crystal layer provided between the array substrate and the color filter substrate,
wherein the touch section comprises:
a touch substrate arranged parallel to the color filter substrate and located at a side of he color filter substrate away from the liquid crystal layer;
first electrodes provided on the touch substrate and configured to sense user's touch so as to generate a touch signal: and
second electrodes provided on the color filter substrate and configured to output he touch signal.

2. The touch display panel according to claim 1, wherein the first electrodes and the second electrodes are arranged in a staggered manner so as to form a matrix structure.

3. The touch display panel according to claim 1, wherein third electrodes for displaying are provided at a display region of the color filter substrate, the second electrodes are provided at a non-display region of the color filter substrate, and the third electrodes and the second electrodes are arranged independently of each other.

4. The touch display panel according to claim 3, wherein the color filter substrate comprises:
a base substrate;
black matrices provided at a non-display region of the base substrate; and
pixel units provided at a display region of the base substrate,
wherein the second electrodes are provided on the black matrices and the third electrodes are provided on the pixel units.

5. The touch display panel according to claim 1, wherein the first electrodes are provided at a surface of the touch substrate close to the color filter substrate.

6. The touch display panel according to claim 1, wherein the touch substrate is a glass substrate.

7. A display device, comprising the touch display panel according to claim 1.

8. A method for manufacturing a color filter substrate for use in a touch display panel, comprising steps of:
forming black matrices on a base substrate by a patterning process;
forming pixel units by a patterning process;
forming second electrodes on the black matrices by a patterning process; and
forming third electrodes on the pixel units by a patterning process.

9. The method according to claim 8, wherein the second electrodes and the third electrodes are formed by a single patterning process.

10. The display device according to claim 7, wherein the first electrodes and the second electrodes are arranged in a staggered manner so as to form a matrix structure.

11. The display device according to claim 7, wherein third electrodes for displaying are provided at a display region of the color filter substrate, the second electrodes are provided at a non-display region of the color filter substrate, and the third electrodes and the second electrodes are arranged independently of each other.

12. The display device according to claim 1 wherein the color filter substrate comprises:
a base substrate;
black matrices provided at a non-display region of the base substrate; and
pixel units provided at a display region of the base substrate,
wherein the second electrodes are provided on the black matrices and the third electrodes are provided on the pixel units.

13. The display device according to claim 7, wherein the first electrodes are provided at a surface of the touch substrate close to the color filter substrate.

14. The display device according to claim 7, wherein the touch substrate is a glass substrate.
